(19) United States
(12) Patent Application Publication
(10) Pub. No.: US 2013/0140350 A1
(43) Pub. Date: Jun. 6, 2013

(54) Compressively Bound Packaging Assembly

(71) Applicants: Joseph F. Noferi, Lincolnwood, IL (US); Ralph L. Dillon, Mundelein, IL (US)

(72) Inventors: Joseph F. Noferi, Lincolnwood, IL (US); Ralph L. Dillon, Mundelein, IL (US)

(21) Appl. No.: 13/680,362

(22) Filed: Nov. 19, 2012

Related U.S. Application Data
(63) Continuation-in-part of application No. 11/594,187, filed on Nov. 8, 2006.
Application No. 11/594,187 is a continuation-in-part of application No. 11/082,984, filed on Mar. 18, 2005.

(51) Int. Cl. B65D 71/06; B31B 1/26

(52) U.S. Cl. CPC B65D 71/06; B31B 1/26
USPC 229/87.18; 493/162

(57) ABSTRACT

A composite integrated package for withstanding the loads encountered in vigorous transportation comprising a one-sheet blank, which when folded, forms double-walled spacers in the center of the package, calls and base for the package. Substantially identical articles are inserted in compartments formed between the double-walled spacers and the vertical walls, and the base supporting the articles in the compartments. At least one tensioned inelastic binding member contacts and applies a compressive force in a horizontal plane to the side walls and the double-wall center spacers of the package and further compressing the articles to form a stable, unitary, and load-bearing structural unit.

This application is a continuation-in-part of U.S. patent application Ser. No. 11/594,187, filed Nov. 8, 2006, which is a continuation-in-part of U.S. patent application Ser. No 11/082,984, filed Mar. 18, 2005.

### BACKGROUND

This invention is directed to strap-reinforced compressed package assemblies, including paperboard packages with separation of wares in the package, and the integration of the articles in the package with separation spacers, a tensioned strap, and the package itself, to form a tightly-held load-bearing structural unit suited to multi-layer palletizing, the rigors of transportation, storage and shelf display purposes, with significant economic and ecological benefits.

Paperboard packaging is extensively used for the transportation and display of goods. Current packaging practice does not follow structural engineering principles of integrating all the elements of a package contents with those of the packaging, per se. Thus the available, intrinsic strengths of the articles forming the package contents are not utilized with that of the package per se to provide a robust integrated package unit.

This failure to optimize package strength is then reflected in potential failure of individual packages. This failure to optimize package strength can also be reflected in potential failure of the aggregated transported load structure. There can be consequent damage to the integrity of a whole pallet load, consequent to the stresses resulting from the static and dynamic forces encountered in transportation and storage.

Current packaging practice relies in large measure on the structural strength and rigidity of the exterior carton per se for pallet load stability, thus requiring a cardboard box structure of undue strength and rigidity, with correspondingly high cardboard and glue content. The profligate use of materials and energy to construct and then recycle such monocoque packaging for multi-layer palletizing, transportation and storage is a little-recognized but important factor that contributes to the generation of greenhouse gases, global warming, the denuding of forests and pollution of water resources.

The current modes of packaging frequently permit relative movement and fretting between adjacent articles within a package, which translates, under shipping conditions, into goods articles damaged from mutual impact with other goods articles within the package. Such internal movement of articles within a package can include sliding, spinning, pivoting, and tilting, and can result in skewing of articles in the package, which renders the packaging unstable, thus destroying the stability and integrity of the pallet load, with consequent further damage to packages and their contents.

The prior use of strapping has been generally ineffective, and raises problems of pallet-load-bearing stability, having been used primarily in a bundling role, with a failure to recognize the strap's potential contribution as an integrated load bearing structural component. Earlier theoretical packaging work generally resulted in undependable packages in the load-bearing sense with predictable failures. These shortcomings are particularly disadvantageous in the supply and distribution service, where the primary focus is on palletized handling and transportation of packages of wares, so that commercial application in the supply chain was not achieved.

### SUMMARY OF THE INVENTION

The present invention provides a transportation suitable package assembly of significantly reduced packaging material content, being based upon the principle of combining the structure and load bearing capability of the goods articles in the package with the structure of the package per se, using tensioned binding members, such as inelastic straps to compress the package and its contents of goods articles into an integrated, stable, structural load-bearing unit.

The long-standing problem of constructing a suitable reduced material content package for substantially vertical containers that can independently withstand the rigors and dynamic forces encountered during transport and distribution, and subsequently function as a storage and/or display package, is solved by combining the package components, the articles, and sheet blank with a compressively engaged binding member so as to immobilize the elements in an integrated unitary structure that will not cant, skew or otherwise deform when impacted by external forces.

The present invention satisfies the long felt need of packaging professionals to create a more robust package assembly that better protects contents, reduces overall package cost and/or minimizes package weight and dimensions, creates a more environmentally-friendly assembly that consumes less resources and materials to produce and is easier to recycle/dispose, and creates a shelf-ready or pallet ready display assembly that requires minimal handling by retailers that can independently survive distribution handling. This package assembly meets each of those objectives and further affords carrier attributes.

It will be understood that to meet the needs of industry, packages are required to be suited for loading onto pallets. Packages should also to be able to withstand the rigors of long-term rugged transportation and potential mishandling. In this context, more than simple load-bearing capability of the package, its contents, and the contents of the containers is required, as transverse dynamic (i.e. skewing and pivoting) forces during transportation may be an inescapable reality, so that resistance to skewing loads may be an essential characteristic of the subject packages, which are referred to as “substantially rigid,” to encompass the requisite anti-skewing capability.

Separation between articles or containers within the package of the present invention is provided by the provision of spacers. Spacers are sandwiched by the tensioned binding member and members against the walls of the articles in the package, serving as a frictional linking element to prevent skewing of the articles in the package, and further integrating the package and its contents into a stable unitary structural load-bearing, substantially rigid unit that can be arranged in layers upon pallets. Spacers provide positional conformance and relative immobility of the articles.

Such pallet loads may consist of a plurality of packages of a single, uniform product, or may consist of mixed, multi-product pallets, for convenient shipping and distribution in the supply chain.

The open product faces that result from the subject invention are particularly helpful in affording improved package ventilation, in the case of products requiring a changing of packaged product temperature, by allowing faster temperature stabilization, with concomitant savings in plant cooling/heating cycle time and operating costs.

Further advantages of the present system are: the provision of pallet loads of enhanced stability; improved capability for palletizing with a mixture of goods packages; faster shelf transfer due to reduced de-packaging requirements; reduction in material return shipment and discard; facilitated package breakdown due to reduced adhesive affixed joints and reduced use of glue, with improved return handling and transportation; and enhanced re-use of packaging.

The rising costs of packaging, in both materials and labor costs for packaging production and for the handling of packaged goods, together with the adverse impact upon the environment from the higher levels of corrugate production presently required, all combine to make commercial application of the present invention both feasible and highly desirable.

Thus, there is provided a package construct having an outer wall structure; a plurality of articles such as containers in tightly packed relation, spacers and spacer walls between some articles, and tensioned binding means wrapped about the wall structure in compressing relation with the wall structures of the plurality of articles and the spacers, to provide a substantially rigid unitary structural unit well-suited for stacking in self-supporting, multi-layers, including palletization for storage and shipping. In the present invention, the walls, spacers, and containers need not be of the same height.

A package of the present invention may contain rigid articles and alternatively may contain semi-rigid articles. The articles have a load bearing capability. The individual articles within a package assembly must be substantially uniform. The individual articles within a package assembly should have a substantially vertical wall. The articles should be generally rectangular and alternatively should be generally cylindrical or any other shape as is known in the art. The articles should have at least two outer contact points that are vertically displaced, the contact points being the points of contact between articles, spacers, and walls. The articles can be containers, goods, packages, tubes, cans, bottles, jars, cartons, barrels, boxes, carboys, and drums among others.

Spacers also provide a protective cushion between the articles of the package, and also protect adjacent articles. Spacers can be divider media, flaps, cut-outs, die-cuts, a protrusion between containers, inter-spacial material, occlusions, affixments, and independent material.

The spacers can be paper, paperboard, plastic or paperboard corrugate, hot melt and other adhesives, expanded and non-expanded plastics, labels and sleeves, carpet, rubber, fabric, preformed egg-carton style material, plastic ring carriers such as Hi Cone® brand, semi-structural and structural wood/cellulose/oil-based product. A spacer can comprise multiple spacers, and can be composed of a combination of materials.

The spacers must frictionally engage the articles. Each article is compressively engaged with at least one other article and at least one spacer. In instances where the spacer provides structural support for top load, the spacer can be reinforced to provide added stiffness and more crush resistance to enhance load carrying ability.

A package of the present invention can be handled as a structural unit, in the manner of a traditional rigid box.

The package of the present invention also serves favorably for display purposes as individual package constructs by the simple expedient, in many instances, of removing a binding member from a de-palletized package. The packages also lend themselves to pallet, multiple construct displays.

The surfaces of the packaging lend themselves to printed advertising, and for purposes of contents determination in warehouses and storerooms. The reduction in material likewise lends itself to increased article visibility and package contents determination.

In addition to stabilizing the integrated package, the use of interposed spacers between the articles also limits and prevents mutual working and fretting between the goods articles during prolonged and rugged shipping and handling.

The simplified packaging of the present invention protects the package contents against damage due to impact with adjoining package units and/or the application of external forces by distributing forces to other package members that are coupled to each other, stabilizes product content against mutual slipping, sliding, skewing and impact, and the packaging and its contents form structural, load bearing unit, which function in a support role to overlying layers of packages in multi-tier pallet loads.

The use of a tensioned binding member such as strap can serve to trap, compress and immobilize the intervening spacer members and the articles in the package, in a compressed relation with adjoining product article surfaces. Multiple binding members can also be used. This stabilized contact induces high frictional forces between the compressed surfaces, such that the spacer members are effectively anchored, and serve as effective bracing struts between package wall, spacers, and the article per se. These high frictional forces also oppose skewing and pivoting tendencies of the articles under transportation forces.

The tensioned binding member affixes the outer wall at some point along its height. The wall is also affixed to the base. Thus, the walls of the subject package are cantilevered. In some instances, the spacer may also be cantilevered.

In the present invention, there is usually a cantilevered section of the outer wall and alternatively of the center vertical spacer. That cantilever section is the unsupported portion of the wall that extends above the top strap and is not compressed by articles on both sides. In those packages where the articles have a shoulder and the center wall extends to the top of the package, the cantilever portion of the wall is the portion that extends between the shoulder and the top.

Uniquely, some embodiments of the present invention provide a strong vertical supporting cantilevered wall because the wall section is supported and fixed at a point by a binding member. This greatly decreases the effective column height and greatly reduces flexure of the wall. Additionally, the midpoint support shortens the effective column length of the strap-encircled containers and may make the articles themselves cantilevered sections. It will be apparent to one skilled in the art that the load carrying capacity of a wall can be enhanced by shortening the effective length of the cantilever. Standard structural engineering formulas such as Euler's formula for cantilever columns and cantilever walls, show that a mid-point column or wall brace such as the tensioned binding member of the present invention will effectively shorten the effective length of the wall or columns thus increasing resistance to buckling and enhancing the load carrying capacity of the wall or column. Less material can be used to accomplish the same load result. Alternatively, a greater load capacity can be gained from the same wall material construct. Prior art that includes boxes or typical inserts are usually attached to adjoining right angle walls and do not have cantilevers and do not have midpoint support.

The tensioned binding member of the present invention compressively interconnects the entrained articles. Each article is in compressive abutment with at least one of another article, a spacer, and a wall. Impact forces are distributed across the compressively interconnected array of articles. The binding member applies lateral compressive force to the package. The compressive force generates frictional forces among and between the spacer, wall, and article.

In a subject package, containing a number of such stabilized product articles, the package, combined with the articles, becomes a structural unit with enhanced stability and load bearing and load sharing capability. In many instances, such as semi-rigid and rigid articles or containers per se, the articles and the paperboard constructs can serve as rigid components, compressed together and integrated by the classic compressive forces of the binding member into a substantially rigid, load-bearing package unit.

When a container such as a bottle is loaded with material, the material in the bottle produces a vertical load and an axial horizontal load. The vertical load is the weight of the entrained material and the top load weight from any material that is above the container. However, because fluid equalizes pressure in all directions, a horizontal axial load presses against the container walls with a force equal to the top load. As that top load and corresponding axial load increases, the containers walls have a tendency to stretch horizontally in bulging fashion, or after an impact to fracture at the weakest wall portions. When containers bulge, the top surface of the containers has a tendency to sink and support less load. If the load is sufficient then a container can start to collapse and deform, which in turn increases the load on adjoining containers, causing a cascade of failure and an overall shipping unit collapse. The current invention precludes this failure by providing axial support around the articles that presses back against the increasing axial load by means of the tensioned binding member.

The positioning of the tensioned binding member is typically determined by the physical properties and attributes of the articles. The tensioned binding member can be located in recessed cut-outs, in notches, and directly on the walls and articles. The cut-outs can also form associated spacers by which the tensioned binding member compresses each spacer into engagement with an adjacent article. The tensioned binding member can engage the articles directly. The location can serve to secure non-glued package components.

The use of a tensioned binding member possessing significant inelasticity facilitates both manual and machine deconstruction/reconstruction of the subject packages, by hand and by machine using the same package components, while assuring maintenance of the requisite compressive forces applied by the tensioned binding member to sustain package integrity.

The securing tensioned binding member of the present integrated package may utilize a variety of strap features to optimize the use of these packages, both in packing and unpacking, and in repackaging. Such binding members are selected from a wide range, including self-adherent strap, pealable strap, friction-welded strap, strapping with interlocking tabbed ends that are separable by transverse sliding disengagement, and knotted strapping having a pull-release free end. The binding member commonly used is a strap made of a plastic such as polypropylene or PET, but the tensioned binding member can be metal, paper, fiber, plastic, twine, cord string, line, wire, The binding member must be relatively inelastic, tensionable and joinable after tensioning.

The lateral extension of the outer walls can exceed, equal and be less than the combined length of the articles adjacent to the wall. In an embodiment, the tensioned binding member extends around the exterior corners of the assembly walls, which is dictated by the shape of the articles. When the walls are equal to or longer than the combined length of the articles, the exterior walls can be planarly indented with a slot or occlusion to allow the tensioned binding member to engage the articles for wraparound. The walls can be cut along the folded base to allow a binding member to wrap around the containers so that the tensioned binding member engages the walls compressively into frictional contact with the containers. Where the walls are shorter that the combined articles and the binding member is above or below the walls, the tensioned binding member will directly engage the articles and the articles will form the corners of the package.

The material generally used in carrying out the present invention is a sheet blank. The sheet blank can be corrugated paperboard, wherein the inherent stiffness and compressive strength of the “board” in line with the corrugations is utilized where feasible to enhance the strength and rigidity of the finished package. Such corrugate typically has the property of laying flat when unpackaged, for facilitated return and re-use, or recycling. Alternatively, other materials such as molded, fabricated members, cardboard, plastic, paper, and support sheets may be used functionally to serve the purposes normally envisioned for paperboard.

A further, major advantage of the subject packaging system is the facilitation of product handling from pallet to shelf, wherein the removal of the tensioned binding member then enables the package contents to be bulk-transferred to the shelf in the carton and carton portion, in a readily viewable and hand-accessible condition, without further unpacking, providing significant manpower reduction. The package can be slide transferred from the paperboard portion, which acts as a magazine. The package can be positioned on a shelf and the binding member removed. This obviates the current practice of carton slashing with a box cutter. The use of glues between surfaces of the board package and the articles can provide additional integration and stability to the package, while facilitating recycling by enabling the ready reduction of glued corner pieces to their original planar form.

Environmentally, a package constructed in accordance with the present invention leads to significant and measurable reduction in the mass of cardboard required per unit of goods shipped, and the elimination of one ton of cardboard production has been equated to a one ton reduction of carbon dioxide emissions, so that significant ecological benefits clearly accrue from this invention.

In one embodiment, the present invention comprises a unitary load-bearing package formed from a single blank of cardboard or paperboard product that is scored and folded into a fourfold package having a plurality of double-walled spacers in the center of the package when the blank is folded inwardly along a first plurality of fold lines to form several compartments in the package. Side portions of the package are attached to the corners of the blank, and the side portions form the outer walls of the package when folded along a second plurality of fold lines. The corners, upon folding of the blank, form a base portion of the compartments. A plurality of articles having rigid or semi-rigid side walls are located in each of the compartments and are supported by the base portion.

At least one tensioned inelastic binding strap extends horizontally around the package and is in contact with each of the articles through a plurality of recesses in the package side walls in which the tensioned strap resides. The tensioned strap applies a tight compressive force to the outer side walls of the package, the article walls, and the double-walled spacers to form a unitary load-bearing transportation package, such that the walls of the articles in the package, as well as the tensioned binding member or strap, the spacers, and the package itself combine to resist the load or transport forces on the package generated under rigorous conditions.

A further embodiment of a composite integrated package can be used for the transportation, storage, and display of a plurality of substantially identical articles. The package is made from a single sheet blank. The blank has a first fold line. A double-wall center spacer is formed by folding the blank inwardly along the first fold line. The double-wall center spacer has an apex formed at the first fold line. The package has a base portion adapted to receive a plurality of substantially identical articles. The base portion comprises a first and second article-receiving base, where the first article-receiving base is foldably attached to the double-wall center spacer along at least a first base fold line. The second article receiving base is foldably attached to the double-wall center spacer along a second base fold line. The package has two vertical walls foldably attached to the two ends of the base portion along two wall fold lines. The two vertical walls are substantially parallel to the double-wall-center spacer. A plurality of substantially identical articles is positioned between the double-wall center spacer and the vertical walls, and the base portion receives and supports the plurality of articles. Each article is compressively engaged with the adjacent articles on the same side of the double-wall center spacer, and each article is compressively engaged with at least a portion of the double-wall center spacer. At least one tensioned binding member is in contact with and applies compressive forces in a horizontal plane to the vertical walls, and the first tensioned binding member further compresses the articles. The articles are compressed against the double-wall center spacer and vertical walls in an immobilized position within the package to form a stable, load-bearing package unit.

Another embodiment of the present invention comprises a unitary load-bearing package formed from a single blank of cardboard or paperboard product that is scored and folded into a W-shaped package. The package has a plurality of walls, spacers, and base portions formed by folds and cuts. A plurality of articles having rigid or semi-rigid sidewalls are located between the walls and spacers and supported by base portions. A first tensioned binding member horizontally encompasses the circumference of the package and is in contact with the walls and articles. The tensioned binding member applies a compressive force to the walls, spacers, and articles to form a unitary load-bearing transportation package, where the walls of the articles in the package, as well as the tensioned strap, the spacers, and package walls combine to resist the load or transportation forces on the package generated under rigorous conditions.

### BRIEF DESCRIPTION OF THE DRAWINGS

FIG. 1 is a layout view of a single blank of cardboard showing the cutout portions and fold lines prior to folding the blank into an illustrative embodiment of the W-shaped package of the present invention;

FIG. 2 is an isometric projection of the blank shown in FIG. 1 as folded into a package configuration of the present invention.

FIG. 3 is an isometric projection of the assembled package configuration of the present invention as illustrated in FIGS. 1 and 2 with a tensioned strap and inserted articles.

FIG. 4 is a layout view of a single blank of cardboard showing the cuts and fold lines prior to folding the blank into an alternative illustrative embodiment of the W-shaped package of the present invention.

FIG. 5 is an isometric projection of the blank shown in FIG. 4 as folded into a package configuration.

FIG. 6 is an isometric projection of the assembled package configuration of the present invention as illustrated in FIGS. 4 and 5, with a tensioned strap and inserted articles.

FIG. 7 is an isometric projection of an alternative embodiment of the assembled package configuration of the present invention.

FIG. 8 is an isometric projection of an alternative embodiment of the assembled package configuration of the present invention showing a window in a wall of the package.

FIG. 9 is plan view of the of an alternative embodiment of the assembled package configuration of the present invention showing additional spacers between articles in a linear row.

FIG. 10 is an isometric projection of an illustration of a blank folded into a package configuration of the present invention showing D-cuts in the base and a handle portion.

FIG. 11 is a layout view of a single blank of cardboard or paperboard for the fourfold embodiment of the present invention.

FIG. 12 is an isometric view of the fourfold package constructed from the blank of FIG. 12.

FIG. 13 is an isometric view of the fourfold package of FIG. 12 showing two tensioned straps and articles inserted.

### DETAILED DESCRIPTION OF THE ILLUSTRATED EMBODIMENTS

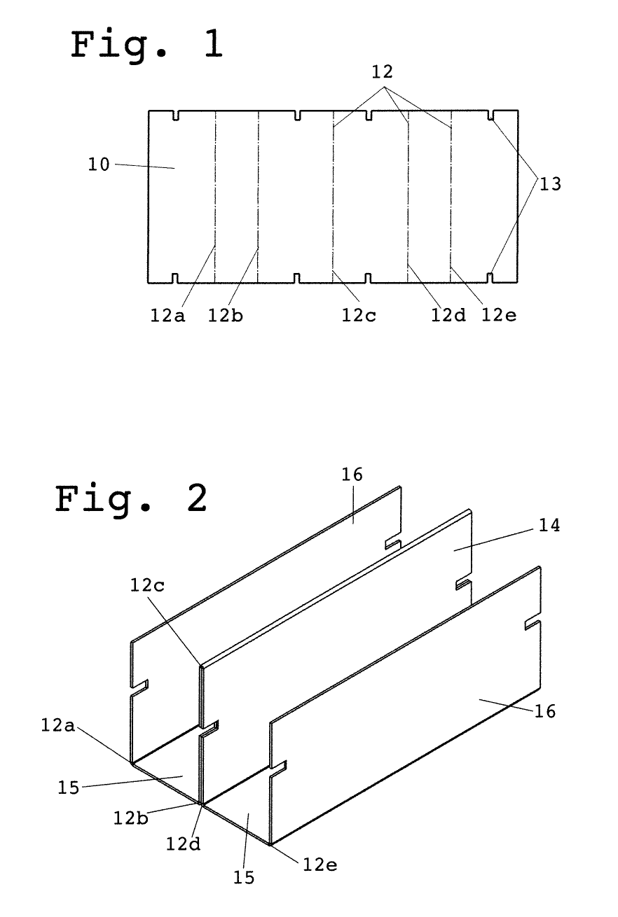

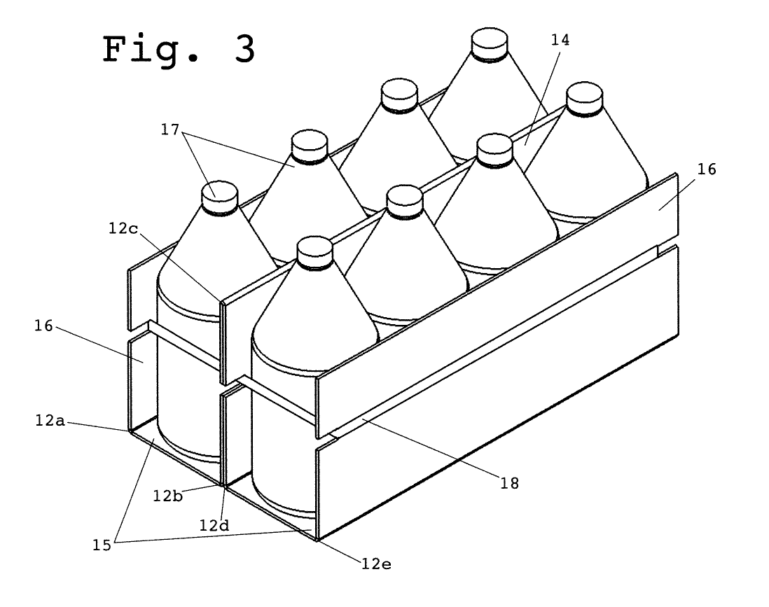

Referring to FIGS. 1, 2, and 3, FIG. 1 shows a single piece of sheet blank used to form an embodiment of the present invention, while FIG. 2 shows the sheet blank of FIG. 1 as folded to form a package having a double-wall center spacer, illustrating certain cuts providing recesses adapted to receive a compressive binding member such as a tensioned strap. FIG. 3 shows the embodiment of FIGS. 1 and 2 having articles located within the walls and spacer, and the walls, spacer, and articles all being compressed by a force in a horizontal plane applied by the tensioned binding strap member. The strap member is tensioned and located in recesses in the side walls, and applies a compressive force to the package side walls, the articles, and the double walled spacer.

The sheet blank 10 in FIG. 1 is substantially rectangular. The sheet blank 10 has scores 12 where it is to be folded as represented by the dotted lines, and the result of folding is illustrated in FIGS. 2 and 3. The sheet blank also has cutouts 13 for receiving a tensioned binding member such as a tensioned strap 18 shown in FIG. 3. In the illustrated embodiment of FIGS. 1, 2 and 3, there are five fold lines 12a, 12b, 12c, 12d, 12e in the sheet blank defining where the sheet blank 10 is to be folded. The blank 10 is folded in half at the first or center fold line 12c forming the double-wall center spacer 14 of FIGS. 2 and 3. The double-wall center spacer 14 has an apex formed at the first fold line 12c. At first base fold line 12b and second base fold line 12d, the blank is folded outward from the double-wall center spacer 14, forming two article-receiving bases 15. The blank is again folded at 12a and 12e upward forming vertical walls 16. The erected sheet blank shown in FIG. 2.

FIG. 3 illustrates the final package and inserted articles 17 with the erected sheet blank. Articles 17 are placed within the erected sheet blank with the articles supported by bases 15. In this embodiment, there are eight articles 17 and one tensioned binding member 18. The binding member 18 is inelastic and the tension laterally compresses the walls 16, spacers 14, and articles 17 together. The articles 17 are thus bound together in a unitary transportation load-bearing structure, resisting the forces that bear on the walls 16, spacers 14, and articles 17. The package is friction stabilized and extremely stiff, with the articles 17 being immobilized in three planes by the wrapper, spacer, and tensioned straps and prevented from movement relative to the other articles and from movement relative to the remainder of the package. The compressive force of the tensioned binding member keeps the articles from skewing and pivoting off their vertical axis while being subjected to transportation and other load forces.

While illustrated as an eight-article package, it will be readily understood that multiples of similar blanks can be formed to have pluralities of spacers and alternatively to receive additional, or less, pluralities of articles.

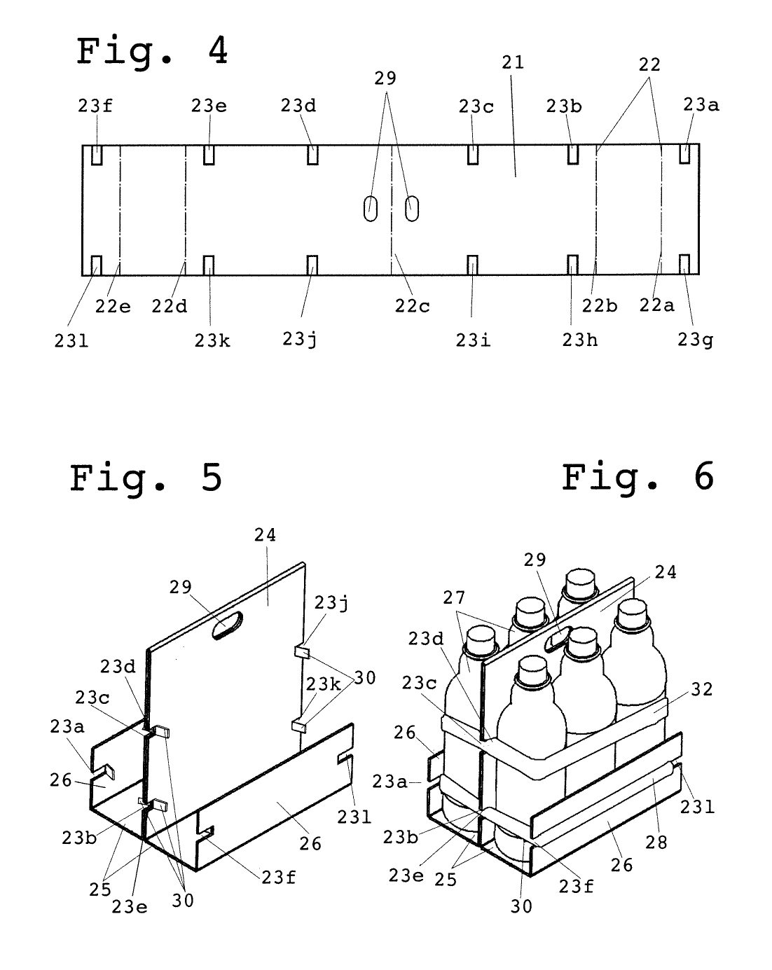

FIGS. 4, 5, and 6 illustrate an alternative embodiment of the present invention. FIG. 4 shows a paperboard blank 21 with fold lines 22a, 22b, 22c, 22d, 22e and recess cuts 23a, 23b, 23c, 23d, 23e, 23f, 23g, 23h, 23i, 23j, 23k, 23l located in opposed juxtaposition at the lateral side edges of blank 21. Flaps 30, shown in FIG. 5, remain attached to blank 21 at one end of each paperboard flap 30, and extend outward from these respective panel portions. Two cut out handle portions 29 are formed in blank 21.

FIG. 5 illustrates the blank 21 of FIG. 4 as erected, with the two central portions of the blank folded along fold line 22c against one another to form double-wall center spacer 24. Two other panels of blank 21 are folded outward along fold lines 22b and 22d to form bases 25 on either side of spacer 24. The outermost panels of blank 21 are folded upward along fold lines 22a and 22e to form walls 26.

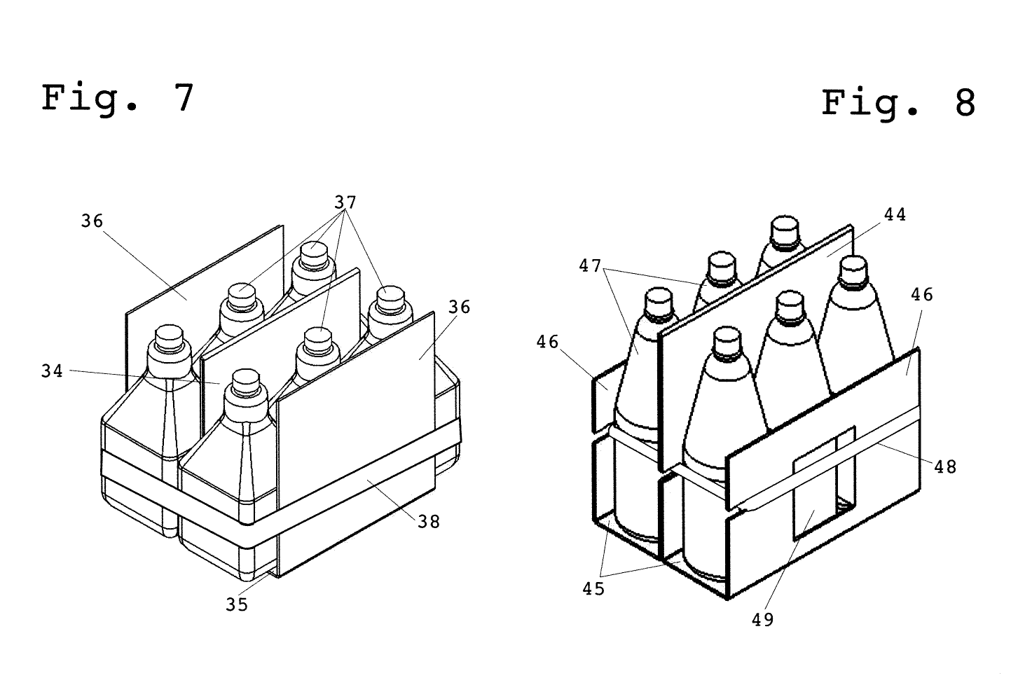

FIG. 6 shows the final package and the articles 27 inserted onto bases 25, and a first tensioned binding strap member 28 extending through the recesses 23a, 23f, 23g, and 23l and around the side walls 26. The tensioned strap 28 applies a compressive force to the package side walls 26, the articles 27, and the double-walled spacer 24. The tensioned binding member 28 fits in the cutout recess 23a, 23f, 23g, and 23l and compresses the flaps 30 against the articles 27, providing a frictional component compressed between the tensioned binding member 28 and the articles 27.

In the embodiment of FIGS. 4, 5, and 6, a second tensioned binding member or strap 32 is shown extending around the articles 27, compressing the articles 27 on each side of the spacer 24 into abutting contact with each other, and into compressive contact with spacer 24 and corresponding wall 26. The package is friction stabilized and extremely stiff, with the articles 27 being immobilized in three planes by the folded blank 21, spacer 24, and tensioned binding members 28 and 32. The articles 27 are prevented from movement relative to the other articles and against movement relative to the remainder of the package. The compressive force of the tensioned binding member 28, 32 keeps the articles from skewing or pivoting off their vertical axis while being subjected to transportation and load forces.

FIG. 7 illustrates an alternative embodiment of the present invention. In this embodiment, there are six articles 37, and a single tensioned binding member or strap 38. Certain of the articles 37 do not all fully rest on the bottom portions 35, and a small portion of the end articles 37 extend outward beyond the bottom portions 35. Binding member 38 compresses the walls 36, the articles 37, and spacer 34 together such that each of the articles 37 are held immobile relative to the walls 36, and spacer 34. In this embodiment, the walls 36 and double-wall center spacer 34 are of equal height as the bottles 37.

FIG. 8 illustrates an alternative embodiment of the present invention. In this embodiment, six articles 47 are sitting on base 45, and a tensioned binding member 48 compressively encircles the articles 47, package walls 46, and double-wall center spacer 44. In this embodiment, the walls 46 are of lesser height than height of the spacer 44 or of the articles 47. In this illustration, a window cutout 49 is also provided in the wall 46 for improved product identification.

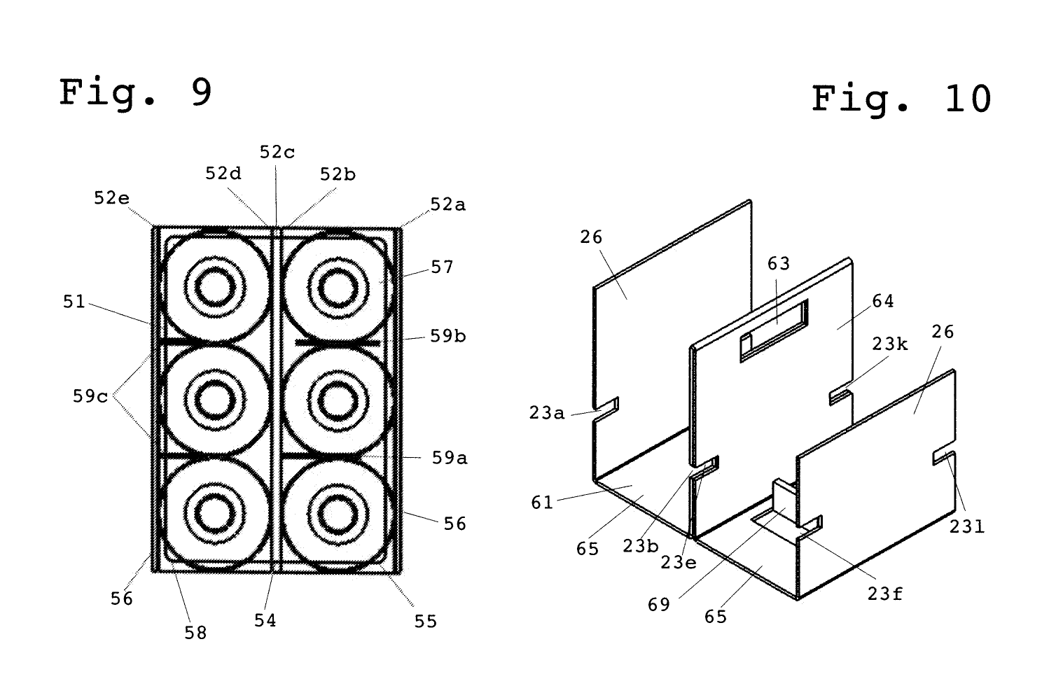

FIG. 9. Illustrates a top view of an alternative embodiment of the present invention having additional spacers. Spacer 59a protrudes from a three-sided cut in the center spacer 54. Spacer 59b is formed from a three-sided cut and is shown extending upward from the base 55. Spacers 59c are formed from three-sided cuts in the outer wall 56. The package of FIG. 9 is made from a one-piece blank 51, having fold lines 52a, 52b, 52c, 52d, and 52e, similar to the blank in FIGS. 1 and 4. The added spacers increase the friction between the walls 56, center spacer 54, and containers 57, resulting from the compression forces created by tensioned binding member 58. It should be readily understood that the blank 51 need not be one piece and that additional constructs could be added such as a stiffening support member between the center spacer 54, and alternatively use of an adhesive.

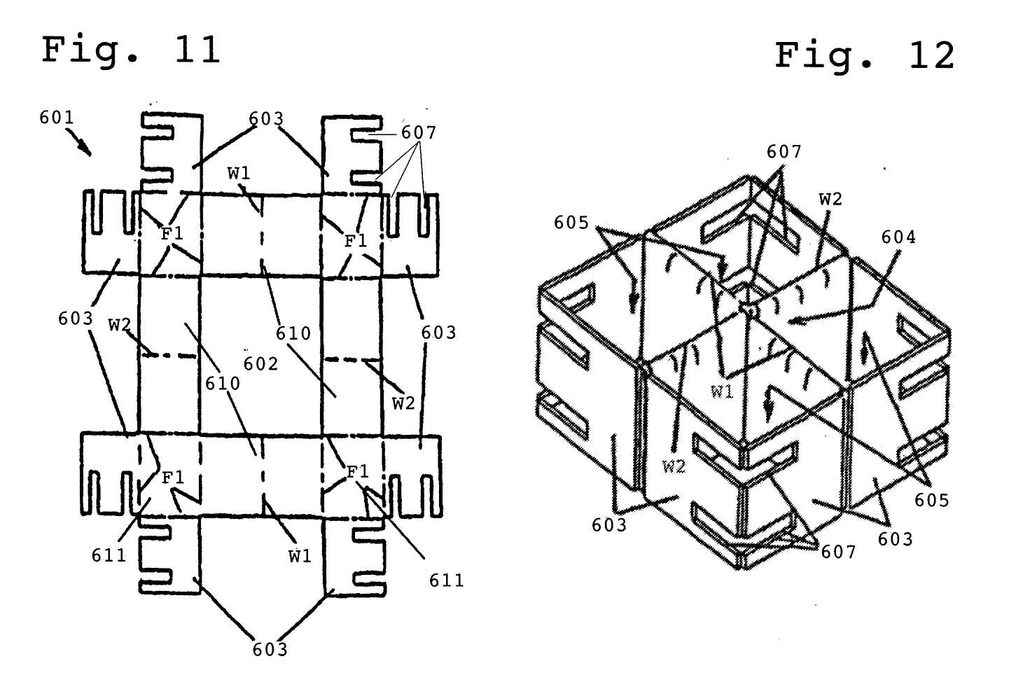

FIG. 10 illustrates an erected sheet blank 61 of an embodiment of the present invention, which blank 61 is similar to the blank 21 shown in FIG. 4. FIG. 10 also highlights a D-cut spacer 69 in the bottom portion 65 and a handle portion 63 in the center spacer 64. A plurality of D-cut spacers 69 may be formed in both bottom portions 65, such as one D-cut spacer to be inserted between each article or container where they are in abutment with an adjacent container.

FIG. 11 is a layout view of a single blank 601 of cardboard or paperboard showing the cutout portions and fold lines prior to folding the blank into the fourfold load-bearing package of an embodiment of the present invention. FIG. 11 shows the one piece fourfold blank 601, having a central recess or opening 602. Blank 601, as illustrated, is for creating a package holding four articles 606 (FIG. 13).

The blank 601 is illustrated as being essentially square shaped, and having one pair of foldable side portions 603 at each corner 611, thus providing four pairs of side portions 603 in total. It will be understood that a substantially unlimited range of arrangements of fourfold blanks can be readily fabricated from sheet stock and made into articles and spacers, with differing sizes and variations in relative proportions.

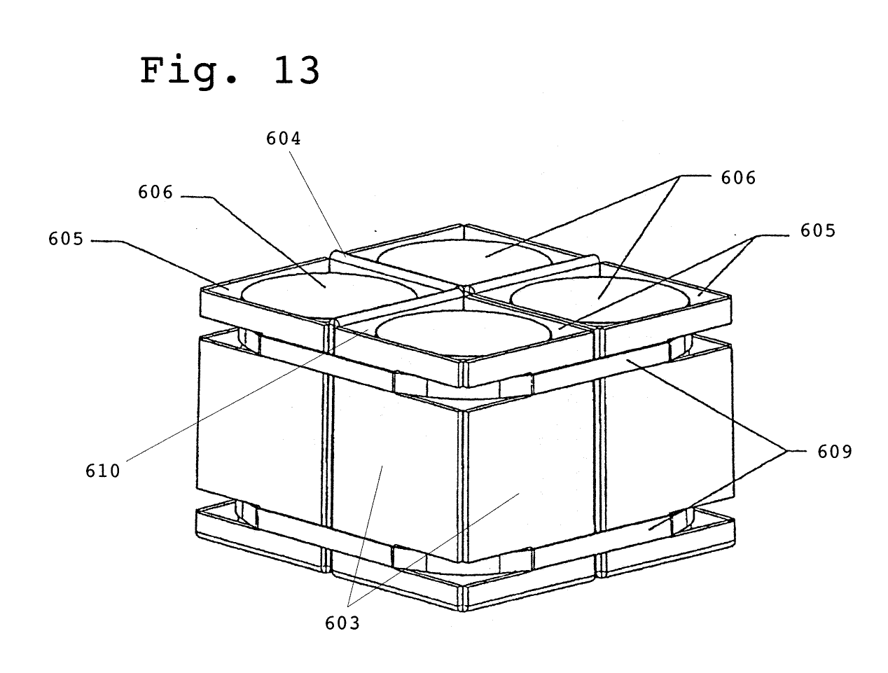

A series of eight fold lines, lines F1 enables the side wall portions 603 to be turned up (or down if required), at right angles to the plane of the blank 601. A series of fold lines W1, W2 enable adjacent panels 610 bordering the recess 602 to be doubled up and folded against the adjacent panel, (see FIG. 12), thereby forming a double-walled cruciform shaped spacer 604 (FIGS. 12 and 13) possessing substantial vertical crush strength. This enables a reduction in the necessary gauge of the board, for many applications. Turning up the side wall portions 603 places the vertical edges of each side portion 603 in edgewise abutment with the side portion 603 on the same corner 611. Since panels 610 are folded on fold lines W1 and W2 into abutment with adjacent panels 610, the four corners 611 of the blank are pulled together into recess 602 adjacent each other to form the base of the package. The side portions 603 at each corner 611 are then located in edge abutment with the side portions 603 on the adjacent corners 611, thus forming four square compartments 605 (FIGS. 12 and 13) into which goods containers or articles 606 are loaded and supported by the package base formed by four corners 611. The adjoined edges of side portions 603 each have strap recesses 607 which are brought into alignment, and in which peripheral, tensioned straps 609 (FIG. 13) are located.

FIG. 13 illustrates the final fourfold package product and articles 606 with the folded blank, four articles and two tensioned inelastic straps 609 extending through the recesses 607 in the side walls 603 and applying a compressive force binding the package together in a unitary transportation load-bearing structure. The upper end of the double-walled cruciform 604 bears a portion of the load when the packages are piled and in transportation. The transportation load forces also bear on each article 606, and on the vertical walls of each article. Articles 606 are supported by the base of the four square compartments 605 by corners 611 formed when the blank 601 is folded into the package shown in FIGS. 12 and 13. Inelastic tensioned straps 609 are tightened to compress the side portions 603 of the package tightly against the outer side walls of the articles 606, and the articles 606 are tightly compressed against the panels 610 of cruciform 604. Therefore the entire package is friction stabilized and extremely stiff, with the articles 606 being immobilized in the package, and prevented from movement relative to the other articles or movement relative to the remainder of the package.

While illustrated in FIGS. 12 and 13 as a four-compartment blank, it will be readily understood that multiples of similar blanks can be cut, to make pluralities of cruciform separator units, with stiff, double thickness walls coupling the units. The upper edge of the central cruciform spacer 604 is coincident with the tops of the articles, and the substantial load-bearing strength of the cruciform spacer 604 and the vertical walls of the articles 606 combine to prevent the load forces encountered in rigorous transportation of the package from destroying the integrity of the package or disturbing the articles in the package. In addition, the compressive force of the tensioned straps 609 maintains articles 606 from skewing or pivoting off their vertical axis while being subjected to transportation load forces.

Specific embodiments of a compression bound packaging assembly have been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, and equivalents that fall within the true spirit and scope of the basic underlying principles disclosed and claimed herein.

We claim:

1. A composite integrated package for the transportation, storage, and display of a plurality of substantially identical articles comprising:
a single sheet blank, said blank having a first fold line;
a double-wall-center spacer formed by said blank folding inwardly along said first fold line; said double-wall-center spacer having an apex formed at the first fold line;
a base portion receiving the plurality of substantially identical articles, and said base portion comprising a first and second article-receiving base, said first article-receiving base foldably attached to said double-wall center spacer along at least a first base fold line, and said second article receiving base foldably attached to said double-wall center spacer along a second base fold line;
a vertical wall foldably attached to each of the ends of said base portion along two wall fold lines, and said vertical walls being substantially parallel to the double-wall center spacer;
the plurality of substantially identical articles positioned between the double-wall center spacer and each of the vertical walls, the articles received by and supported by the base portion, each article being compressively engaged between a portion of a corresponding vertical wall and at least a portion of said double-wall center spacer spacer; and
at least one tensioned binding member in contact with and applying compressive forces in a horizontal plane to the vertical walls, the tensioned binding member further compressing the articles, said articles compressed against the double-wall center spacer and vertical walls with said articles in an immobilized position within and relative to the package and relative to other articles, and forming a stable, load-bearing unit.

2. The composite integrated package of claim 1 wherein at least one of the vertical extending walls has a height that coincides with the height of said articles.

3. The composite integrated package of claim 1 wherein at least one of said vertical extending walls includes at least one recess to receive said at least one tensioned binding member.

4. The composite integrated package of claim 1 wherein recess cuts are formed in the vertical walls, and at least a portion of said vertical walls compressively engaging part of an article wall, said article wall conforming to the shape of said articles.

5. The composite integrated package of claim 1 wherein said at least one tensioned binding member comprises two tensioned binding members, each tensioned binding member located in a separate horizontal plane to secure each article in said package in two horizontal planes in a mutually immobilizing relation and integrating said vertical walls, said articles, and said center spacer to form a stable, unitary, load-bearing transit package unit.

6. The composite integrated package of claim 1 wherein said articles are selected from the group consisting of rigid and semi-rigid materials.

7. The composite integrated package of claim 1 wherein said sheet blank has at least one D-cut, said D-cut extending perpendicular to said vertical walls, and said D-cuts acting as a spacer between said articles, said D-cut creating additional frictional compression between adjacent articles in said package.

8. The composite integrated package of claim 1 wherein said apex is severed.

9. The composite integrated package of claim 1 wherein said single sheet blank comprises at least a first and second sheet blank.

10. The composite integrated package of claim 1 wherein the at least one tensioned binding member axially constrains each of said plurality of articles against deformation under the application of transportation forces to said package.

11. A composite integrated package for transport loads comprising:
a rectangular sheet blank, said blank having a first fold line defining a plurality of panels, said panels forming double-walled spacers in the center of said package when said blank is folded inwardly along said first fold line;
a plurality of base portions foldably attached to each of said double-walled spacers
at least a first side portion foldably attached to each of the base portions, said side portions forming vertical walls of said package;
said double-walled spacers and said side portions forming a plurality of compartments;
a plurality of substantially identical articles inserted in said compartments, said base portions supporting said articles in said compartments, said articles having vertical extending exterior walls;
at least one inelastic tensioned binding member extending in a horizontal plane around said package and contacting said wall portion and said articles, said tensioned inelastic binding member applying a compressive force to compress said walls of said package, said article exterior walls and said spacers against each other, forming a unitary, tightly compressed package with said articles held immobile relative to said spacers, to said walls of said package, and to other articles upon the application of a load force to said package.

12. The composite package of claim 11 wherein said blank is substantially square.

13. The composite package of claim 11 wherein said double-walled spacers are formed in the shape of a cruciform.

14. The composite integrated package of claim 11 wherein said double-walled spacers in the center of said package have a height that coincides with the height of said articles.

15. The composite integrated package of claim 11 wherein said side portions include recesses to receive said at least one inelastic tensioned binding member.

16. The composite integrated package of claim 11 wherein said at least one inelastic tensioned binding member comprises two inelastic straps, each strap placed in a separate horizontal plane to secure each article in said package in two horizontal planes in a mutually immobilizing relation and integrating said walls of said package, said articles and said spacers to form a unitary load-bearing transportation package.

17. The composite integrated package of claim 11 wherein said fourfold blank is made of materials selected from the group consisting of corrugated paperboard, corrugated cardboard, molded members, fabricated members, and support sheets.

18. The composite integrated package of claim 11 wherein the vertical exterior walls of said articles are selected from the group consisting of rigid and semi-rigid materials.

19. The composite integrated package of claim 11 wherein said at least one inelastic binding member is selected from the group consisting of metal strap with securing clasp, self-adherent strap, pealable strap, friction-welded strap, strapping with interlocking tabbed ends that are separable by transverse sliding disengagement, and knotted strapping having a pull-release free end.

20. A structural load bearing package comprising:
a plurality of substantially identical articles;
a first base portion receiving a first article from said plurality of articles;
a second base portion receiving a second article from said plurality of articles, said second base portion substantially coplanar to said first base portion;
a planar spacer adjoining said first and second base portion;
a pair of walls comprising a first vertically extending wall fixedly attached to said first base portion and a second vertically extending wall fixedly attached to said second base portion, each of said first and second walls being parallel to said spacer;
a horizontally extending inelastic tensioned binding member having a predetermined tension encircling said walls, said plurality of articles, and said spacer, said tensioned binding member engaging at least a portion of said plurality of articles and said pair of walls;
a horizontal compressive force created by said inelastic tensioned binding member, said compressive force providing a frictional force acting on said pair of walls, said plurality of articles, and said spacer, said frictional force interlocking and immobilizing said walls, said plurality of articles, and said spacer relative to each other, constraining said articles against movement relative to said walls and said spacers;
a frictional force resulting from said compressive force, said frictional force between at least said first wall, said first article, and said spacer, said frictional force resisting vertical movement of said article plurality;
said walls, said tensioned binding member, said articles, and said spacer, together with said compressive force combing to form a unitary structural load bearing package for said articles.

21. A method for forming a composite integrated package for the transportation, storage, and display of a plurality of substantially identical articles, the method comprising:
forming a first fold line in a single sheet blank;
folding said blank inwardly along said first fold line to form a double-wall center spacer, said double-wall center spacer having an apex formed at the first fold line;
forming base portions by folding a portion of said double-wall center spacer outward, said base portions receiving the plurality of substantially identical articles;
forming vertical walls by folding a portion of said base portions upwardly, said vertical walls being substantially parallel to the double-wall center spacer;
positioning a plurality of the substantially identical articles between the double-wall center spacer and each of the vertical walls, the articles being received by and supported by a corresponding base portion, each article being compressively engaged between a portion of a corresponding vertical wall and at least a portion of said double-wall center spacer; and
compressively binding the vertical walls, the articles, and the double-wall center spacer with a tensioned binding member applying horizontal compressive forces to said vertical walls, to said articles, and to said double-wall center spacer, said compressive binding maintaining said articles, said walls, and said double-wall center spacer in an immobilized position, said articles held immobile relative to the package and relative to other articles, said package forming a stable, load-bearing structural unit.
